(19) United States
(12) Patent Application Publication
(10) Pub. No.: US 2022/0258284 A1
(43) Pub. Date: Aug. 18, 2022

(54) METHOD FOR THE LASER PROCESSING OF A WORKPIECE, PROCESSING OPTICAL UNIT AND LASER PROCESSING APPARATUS

(71) Applicant: TRUMPF Laser- und Systemtechnik GmbH, Ditzingen (DE)

(72) Inventors: Daniel Flamm, Ludwigsburg (DE); Malte Kumkar, Weimar (DE)

(21) Appl. No.: 17/737,038

(22) Filed: May 5, 2022

Related U.S. Application Data
(63) Continuation of application No. PCT/EP2020/079873, filed on Oct. 23, 2020.

(30) Foreign Application Priority Data
Nov. 14, 2019 (DE) 10 2019 217 577.5

(51) Int. Cl. B23K 26/53; B23K 26/067; B23K 26/06; B23K 26/402; B23K 26/0622; C03C 23/00

(52) U.S. Cl. CPC B23K 26/53; B23K 26/0676; B23K 26/0608; B23K 2103/54; B23K 26/402; B23K 26/0622; C03C 23/0025; B23K 26/0648

(57) ABSTRACT

A method for laser processing of a workpiece includes splitting a pulsed laser beam among a plurality of partial beams. Each partial beam has one of two different polarization states. The method further includes processing the workpiece by focusing the plurality of partial beams into a plurality of at least partially overlapping partial regions of a continuous interaction region. Partial beams having different polarization states are focused into adjacent partial regions of the continuous interaction region.

### CROSS REFERENCE TO RELATED APPLICATIONS

This application is a continuation of International Application No. PCT/EP2020/079873 (WO 2021/094072 A1), filed on Oct. 23, 2020, and claims benefit to German Patent Application No. DE 10 2019 217 577.5, filed on Nov. 14, 2019. The aforementioned applications are hereby incorporated by reference herein.

### FIELD

Embodiments of the present invention relate to a method for laser processing of a workpiece.

### BACKGROUND

During the laser processing of a workpiece, in particular during laser ablation, laser cutting, surface structuring, laser welding, laser drilling, etc., it is expedient to split an input laser beam into a plurality of partial beams which impinge or are focused on the workpiece at different positions. The splitting can be effected at a polarizer element, wherein from an input laser beam typically two partial beams having in each case one of two different polarization states, e.g. two partial beams polarized perpendicularly to one another, are formed as output laser beams. It is possible for a plurality of input laser beams that are spatially offset to impinge on the polarizer element. In this case, each of the input laser beams is split into a pair of partial beams having in each case one of two different polarization states.

WO2015/128833A1 describes a laser cutting head having a polarizing beam offset element for producing two linearly polarized partial beams, said beam offset element being arranged in the beam path of a laser beam. The polarizing beam offset element is arranged in a divergent or in a convergent beam path section of the laser beam. The beam offset element can be formed from a birefringent material. With the use of a focusing, magnifying optical unit and a beam offset element arranged downstream of the focusing optical unit in the beam path, the two partial beams can be partly superimposed in the focal plane.

WO2015/5114032 A1 has disclosed a laser processing apparatus for workpiece processing comprising a processing optical unit, wherein an input laser beam is split into two perpendicularly polarized partial beams at a polarizer. The processing optical unit has a longer path length for the second partial beam than for the first partial beam, as a result of which the second partial beam has a longer propagation time than the first partial beam. The second partial beam is altered in at least one geometric beam property vis-à-vis the first partial beam. The altered second partial beam is superimposed on the first partial beam in such a way that both partial beams form a common output laser beam.

WO2018/020145A1 describes a method for cutting dielectric or semiconductor material by means of a pulsed laser, wherein a laser beam is split into two partial beams, which impinge on the material in two spatially separated zones offset by a distance with respect to one another. The distance is set to a value below a threshold value in order to produce in the material a rectilinear micro-fracture running in a predefined direction between the two mutually offset zones. Beam shaping can be carried out on the two partial beams in order to produce a spatial distribution on the material in the form of a Bessel beam.

WO2016/089799A1 describes a system for the laser cutting of at least one glass article by means of a pulsed laser assembly comprising a beam-shaping optical element for converting an input beam into a quasi-nondiffractive beam, for example a Bessel beam. The laser assembly also comprises a beam transformation element for converting the quasi-nondiffractive beam into a plurality of partial beams spaced apart from one another by between 1 μm and 500 μm.

DE 10 2019 205 394.7 describes a processing optical unit for workpiece processing comprising a birefringent polarizer element for splitting at least one input laser beam into a pair of partial beams polarized perpendicularly to one another, and also a focusing optical unit arranged downstream of the polarizer element in the beam path and serving for focusing the partial beams on focus zones, wherein the processing optical unit is configured for producing at least partly overlapping focus zones of the partial beams polarized perpendicularly to one another. The processing optical unit can be configured for producing a plurality of pairs of at least partly overlapping focus zones along a predefined contour in a focal plane, wherein focus zones of in each case two partial beams polarized perpendicularly to one another of directly adjacent pairs at least partly overlap one another.

### SUMMARY

Embodiments of the present invention provide a method for laser processing of a workpiece. The method includes splitting a pulsed laser beam among a plurality of partial beams. Each partial beam has one of two different polarization states. The method further includes processing the workpiece by focusing the plurality of partial beams into a plurality of at least partially overlapping partial regions of a continuous interaction region. Partial beams having different polarization states are focused into adjacent partial regions of the continuous interaction region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show schematic illustrations of two birefringent polarizer elements for producing an angle offset and respectively a position offset between two partial beams polarized perpendicularly to one another;

FIGS. 2a and 2b show schematic illustrations of a processing optical unit with a birefringent lens element for producing a longitudinal offset between focus zones of two partial beams polarized perpendicularly to one another;

FIG. 2c shows a schematic illustration of a processing optical unit analogously to FIG. 2b with the polarizer element shown in FIG. 1a for producing an additional lateral offset of the two focus zones;

FIGS. 3a and 3b show schematic illustrations of an ablating laser processing on a workpiece;

FIGS. 4a and 4b show schematic illustrations of a laser processing that modifies the workpiece material in order to separate the workpiece along a modification contour;

FIGS. 5a and 5b show schematic illustrations of a laser processing that modifies the workpiece material in preparation for an etching process; and

FIGS. 6a and 6b show schematic illustrations of an ablating laser processing for the surface processing of a workpiece.

Detailed DescriptionEmbodiments of the present invention provide a method for laser processing, a processing optical unit and a laser processing apparatus, which enable three-dimensional processing of a workpiece, such as processing of surfaces and/or edges of the workpiece.

Embodiments of the present invention provide a method for laser processing of a workpiece. The method includes: splitting a preferably pulsed laser beam, in particular an ultrashort pulse laser beam, among a plurality of partial beams, each having—in particular in pairs—one of two different polarization states, and also processing the workpiece by focusing the plurality of partial beams in a plurality of at least partly overlapping partial regions (or focus zones) of a continuous interaction region, wherein partial beams having in each case different polarization states are focused into adjacent partial regions of the continuous interaction region. The laser beam can be generated for example in a solid-state laser, in particular in a disk laser or in a fiber laser.

Within the meaning of this application, partial beams having different polarization states are understood to mean linearly polarized partial beams whose polarization directions are oriented at an angle of 90° to one another. However, partial beams having different polarization states are also understood to mean circularly polarized partial beams having an opposite rotation sense, i.e. two left and respectively right circularly polarized partial beams. The conversion of linearly polarized partial beams having polarization directions oriented perpendicularly to one another into circularly polarized partial beams having an opposite rotation sense can be effected e.g. with the aid of a suitably oriented retardation plate (λ/4 plate).

If a (pulsed) laser beam which e.g. is generated by a single-mode laser and has a Gaussian beam profile is split into two or more partial beams and the partial beams are at least partially superimposed, this can result in undesired interference effects if the partial beams have the same or a similar polarization. Therefore, during the focusing of the partial beams, the focus zones or the focus cross-sections cannot be arbitrarily close together, and so the partial beams are generally focused at focus zones or partial regions spaced apart from one another on the workpiece.

During the focusing of partial beams having in each case different polarization states onto directly adjacent partial regions or focus zones, the (partial) superimposition does not give rise to interference effects of the laser radiation from different position or angle ranges, provided that the polarization state of the respective partial beams is uniform over the entire relevant beam cross-section or the respective focus zone. The polarization of a respective partial beam should therefore vary as little as possible over the beam cross-section or over the focus zone/partial region in a position-dependent manner. In this case, the adjacent focus zones can be arbitrarily close to one another, partly or possibly completely overlap and even form homogeneous focus zones, specifically both transversely, i.e. perpendicularly to the direction of propagation of the partial beams, and longitudinally, i.e. in the direction of propagation of the partial beams.

The partial regions are typically lined up along the continuous interaction region, i.e. each partial region (with the exception of the partial regions at the two ends of the interaction region) adjoins exactly two adjacent partial regions and partly overlaps these two adjacent partial regions. In the case of the continuous interaction region, the adjacent partial regions thus typically overlap only to an extent such that they do not overlap the respectively differently polarized partial beam of a further adjoining partial region, with the result that no superimposition of identically polarized partial beams occurs. The continuous interaction region forms a predefined, continuous contour, which is also referred to as a (curved) multispot focus contour or, in the case of a rectilinear contour, as a multispot focus line.

As an alternative to the use of wholly or partly overlapping partial beams having different polarization states, it is also possible to use wholly or partly overlapping partial beams which have a time offset having a magnitude such that practically no interference effects occur. This is typically the case if the time offset corresponds at least to the order of magnitude of the pulse duration or the order of magnitude of the coherence length. As a minimum here generally 50% of the respective smaller value of the two values (pulse duration and respectively coherence length) is chosen as time offset.

The splitting of the laser beam among the plurality of partial beams, each having one of two different polarization states, is typically effected in a processing optical unit.

In one variant, the laser beam passes through a preferably diffractive beam splitter optical unit and at least one preferably birefringent polarizer element during the splitting among the plurality of partial beams. By means of the (e.g. diffractive) beam splitter optical unit, the laser beam can be split among a plurality of partial beams in order to effect beam splitting among a plurality of partial regions or focus zones (spots) in the working volume of the (preferably transparent) material of the workpiece. The focus zones which are produced in the working volume without the use of the polarizer optical unit or the polarizer element are spaced apart from one another in order to avoid the interference effects described further above. The polarizer optical unit or the polarizer element serves to split a respective input laser beam generated by the beam splitter optical unit into two partial beams having in each case different polarization states, in order in this way to fill the gaps between the focus zones and to produce a continuous interaction region. A beam shape or an intensity distribution which generally has a continuous transition, i.e. no zeros in the intensity distribution between the partial beams or between the focus zones/partial regions, thus arises along the continuous interaction region.

It goes without saying that, in contrast to the description above, the laser beam can pass firstly through the polarizer element(s) and only afterward through the beam splitter element or the beam splitter optical unit. The beam splitter optical unit can be configured in the form of a diffractive optical element, for example, but some other type of beam splitter optical unit can also be involved, for example a geometric beam splitter optical unit.

Even though often only one birefringent polarizer element is mentioned in the following description, in principle two or more (birefringent) polarizer elements can also be provided in the processing optical unit. By way of example, in this case, the laser beam which is generated by a (ultrashort pulse) laser source and enters the processing optical unit can be split into two or more partial beams, which each constitute an input laser beam for an associated birefringent polarizer element, or optionally the laser beams of a plurality of laser sources can be used as input laser beams.

In one variant, during the splitting of the laser beam among the plurality of partial beams at a birefringent polarizer element a lateral offset (position offset) and/or an angle offset are/is generated between two partial beams, which are focused onto adjacent partial regions of the continuous interaction region. In this case, the birefringent polarizer element can be configured either for producing a lateral (position) offset or for producing an angle offset or for producing a combination of an angle offset and a position offset between the two partial beams polarized perpendicularly to one another.

With the aid of a birefringent polarizer element, typically in the form of a birefringent crystal, given suitable polarization of the input laser beam, e.g. given an unpolarized input laser beam or given an input laser beam having undefined or circular polarization, the targeted spatial splitting of the input laser beam into its polarization constituents is made possible. Depending on the configuration of the birefringent polarizer element, a well-defined, pure position offset, a well-defined, pure angle offset or a combination of position offset and angle offset can be produced between the two partial beams having the different polarization states.

In order to produce the position offset (without an angle offset), the birefringent polarizer element can have for example generally planar beam entrance and beam exit surfaces aligned parallel. In this case, the optical axis of the birefringent crystal is typically oriented at an angle with respect to the beam entrance surface. If the input laser beam impinges on the beam entrance surface perpendicularly, a pure position offset is produced at the beam exit surface.

In order to produce the angle offset (without a position offset), the birefringent polarizer element can have a beam exit surface that is inclined at an angle with respect to the beam entrance surface. In this case, the optical axis of the birefringent crystal is typically aligned parallel to the beam entrance surface. In this case, at the beam exit surface, the two partial beams emerge from the birefringent crystal at the same position and with a defined angle offset.

In order to produce a combination of position offset and angle offset, for example a polarizer element in the form of a conventional prism polarizer can be used, for example a Nicol prism, a Rochon prism, a Glan-Thompson prism or some other type of prism polarizer (cf. e.g. “https://de.wikipedia.org/wiki/Polarisator” or “https://www.b-halle.de/produkte/Polarisatoren.html”).

In a further variant, during the splitting of the laser beam among the plurality of partial beams at a birefringent polarizer element, in particular at a birefringent lens element, a longitudinal offset is generated between two partial beams, which are preferably focused onto adjacent partial regions of the continuous interaction region. By way of example, a birefringent imaging optical element, in particular a lens element, can be used for producing the longitudinal offset between the partial beams. The birefringent lens element can be configured in a focusing fashion (e.g. as a converging lens) or in a beam-expanding fashion (e.g. as a diverging lens). In the first case, the lens element can form a focusing optical unit of the processing optical unit. However, it has proved to be advantageous if a non-birefringent lens element (focusing lens) is used as the focusing optical unit. For the case where the birefringent lens element has a focusing effect, said birefringent lens element can form a part of the focusing optical unit. In the present application, the term focusing optical unit often denotes the optical element which has the highest refractive power and which is typically configured in the form of a focusing lens (objective lens).

Besides being dependent on the type of laser processing, the arrangement of the birefringent polarizer element(s) in the beam path of the processing optical unit is dependent on whether a lateral or longitudinal position offset and/or an angle offset is intended to be produced. For examples of the arrangement of birefringent polarizer elements in a processing optical unit, reference should be made to DE 10 2019 205 394.7 cited in the introduction, the entirety of which is incorporated by reference in the content of this application. It goes without saying that both a longitudinal and a lateral offset of the focus zones or of the partial regions of the continuous interaction region can be produced by means of a suitable choice of birefringent polarizer elements.

The partial regions or the focus zones of the continuous interaction region can lie in a common plane typically corresponding to the focal plane of the processing optical unit.

Preferably, at least two of the partial regions of the continuous interaction region are offset in a longitudinal direction (e.g. Z-direction), i.e. they do not lie in a common focal plane. In this variant, the continuous interaction region typically deviates from a linear shape, i.e. the interaction region forms a generally curved contour extending in a longitudinal direction. By realizing an additional offset of the partial regions in a lateral direction (e.g. X-direction), it is possible for the continuous interaction region to form practically any desired geometry or contour line in the X-Z-plane. It is also possible, in principle, to produce a lateral offset of the partial beams in two directions (e.g. in the X-direction and in the Y-direction), i.e. the continuous interaction region need not necessarily lie in one plane.

In a further variant, during the laser processing the continuous interaction region and the workpiece are moved relative to one another, wherein the movement is preferably effected along a feed direction. By virtue of the relative movement, the interaction region is moved along a processing path on which e.g. material of the workpiece can be ablated or the material of the workpiece can be structurally modified. The feed direction during the laser processing can be chosen to be constant, but it is also possible for the feed direction to vary during the laser processing. What is effected in the simplest case is a rectilinear feed of the workpiece and the interaction region relative to one another in a direction running transversely, in particular perpendicularly, with respect to the plane (e.g. the X-Z-plane) in which the interaction region lies.

The laser processing or the workpiece processing can be laser ablation, laser cutting, surface structuring, laser welding, laser drilling, . . . , for example. It goes without saying that depending on the type of laser processing the relative movement can be repeated a number of times, e.g. in order to successively ablate a plurality of layers of the workpiece material during laser ablation.

In one variant, the interaction region forms an ablation region for ablating material of the workpiece. In this case, the workpiece can be processed by the material of the workpiece being ablated layer by layer, for example. In this case, the continuous interaction region can be linear and can extend in a focal plane. As a result of a movement of the linear interaction region and the workpiece relative to one another along the feed direction, a respective layer of the workpiece can be ablated. It is also possible to produce an interaction region having a geometry or profile adapted to the contour to be ablated, for example a V-shaped or a U-shaped profile, in order to produce a V-shaped or a U-shaped groove in the workpiece. An interaction region having such an adapted profile can be sunk deeper and deeper into the volume of the workpiece in a plurality of successive ablation steps in order to produce the V-shaped or U-shaped groove and optionally to separate the workpiece into two segments. The profile of the interaction region can optionally be altered during the laser processing. In particular, during successive ablation steps in which material is ablated in each case, a steeper profile of the interaction region can gradually be chosen, i.e. the extension of the profile in a longitudinal direction increases. By way of example, in this case, a V-shaped profile can be chosen gradually to be steeper and steeper in successive ablation steps in order to produce a V-shaped groove in the workpiece.

In a further variant, the ablation region is formed at an entrance-side surface of the workpiece or at an exit-side surface of the workpiece, wherein during the laser processing preferably a predefined, in particular three-dimensional, surface shape is generated at the entrance-side or at the exit-side surface. In this variant, by means of the laser processing a modification of a surface shape or geometry of the surface is performed in order to adapt the latter to a predefined surface shape, e.g. in order to form a wedge-shaped surface, a cylindrical surface or a freeform surface. For this purpose, the profile or the geometry of the interaction region is adapted to the predefined surface shape, more precisely to a cross-sectional profile of the predefined surface shape, and the interaction region is moved relative to the workpiece along the processing path in order to produce the predefined surface shape at the surface. Surfaces having virtually any desired shapes can be produced in this way. After the laser processing, a modifying post-processing of the surface can be effected; by way of example, the surface can be polished.

For the case where the ablation region is formed at the exit-side surface of the workpiece, the workpiece is transparent to the wavelength of the laser beam. In the case of rear-side ablating laser processing, it is advantageous that, in contrast to entrance-side processing, the ablation products do not influence the beam propagation as far as the processing zone. In the case of a transparent workpiece, the entrance-side surface and the exit-side surface can be processed without the workpiece having to be removed from a respective holding apparatus or rotated for this purpose. The transparent workpiece can be in particular a workpiece composed of glass.

In a further variant, the interaction region forms a modification region for the structural modification of the material of the workpiece, wherein the workpiece preferably consists of a material transparent to the laser beam, in particular of glass. In this variant, during the laser processing the material of the workpiece is not ablated, rather a structural modification of the workpiece material is effected. Such a structural modification can consist in a rearrangement of chemical bonds, in the formation of microcracks, etc. during the irradiation with ultrashort pulse laser radiation. The structural modification can produce or promote cracking of the glass material in particular. The glass material can be e.g. quartz glass or some other type of (optical) glass. In the case of a transparent material, the structural modification is not restricted to the surface or to a volume region near the surface, but rather can be introduced practically at any desired location within the volume of the workpiece. A structural modification at the surface of the workpiece is likewise possible, however; by way of example, the structural modification can effect polishing (local melting) of the surface.

It can be advantageous if the geometry of the partial regions or of the focus zones of the interaction region predefines or defines a preferred direction for the cracking. This can be achieved for example by means of an elliptic or oval shape of the focus zones since the cracking is preferably effected along the long axis of the oval or elliptic focus zones.

In a further variant, the workpiece is separated after the structural modification along a modification contour formed during the laser processing in the volume of the workpiece, wherein the separating is preferably effected by a mechanical separating process, a thermal separating process or by an etching process. In this variant, the structural modification serves for effecting prior damage of the material of the workpiece; in this case, the workpiece is separated typically only after the structural modification has been concluded. In the case of the mechanical separating process, e.g. a force or a mechanical stress can be exerted on the workpiece in order to separate or break the latter into two segments. In the case of the thermal separating process, the workpiece can be heated so as to produce a temperature gradient that produces a mechanical stress in the material of the workpiece, said mechanical stress resulting in the separation. The thermal treatment of the workpiece can be effected for example with the aid of laser radiation that is absorbed by the material of the workpiece. This is the case for example for the laser radiation of a CO₂ laser since this laser generates laser radiation at a wavelength of approximately 10 μm, which is absorbed by most materials, inter alia by quartz glass. For the thermal treatment or the thermal separating process, a CO₂ laser beam, for example, can be radiated onto the surface of the workpiece. The separating of the workpiece into two segments can also be effected by an etching process in which the workpiece is placed into an etching bath, for example, after the structural modification.

It is advantageous for the separating if the modification contour extends as far as possible into the volume of the workpiece. The modification structure ideally connects the top side of the workpiece to the underside of the workpiece. The latter can be achieved by means of a suitable three-dimensional profile of the continuous interaction region, which in this case extends over the entire thickness of the workpiece. In order to produce the largest possible extension of the partial regions or of the focus zones in a longitudinal direction or in a thickness direction of the workpiece, it is also possible for the laser beam, more precisely the partial beams, to have a Bessel-shaped beam profile. In this case, for producing the modification contour it is also possible to use a linear interaction region in which the partial regions are not necessarily offset in a longitudinal direction with respect to one another.

Embodiments of the present invention also relates to a processing optical unit for the laser processing of a workpiece, comprising: a preferably diffractive beam splitter optical unit and at least one preferably birefringent polarizer element for splitting a preferably pulsed laser beam among a plurality of partial beams, each having—in particular in pairs—one of two different polarization states, and also a focusing optical unit for focusing the plurality of partial beams in a plurality of at least partly overlapping partial regions of a continuous interaction region, wherein the processing optical unit is configured to focus partial beams having in each case different polarization states into adjacent partial regions of the continuous interaction region. In this case, too, the partial regions are typically lined up along the continuous interaction region.

In one embodiment, the processing optical unit has at least one birefringent polarizer element for producing a lateral (position) offset and/or an angle offset between two partial beams having different polarization states. With regard to the various possibilities for realizing the lateral offset and/or the angle offset, reference should be made to the above explanations in association with the method.

Depending on the respective processing application, it may be expedient to use either a birefringent polarizer element which produces an angle offset but only an insignificant position offset (2 f set-up, e.g. in the case of beam splitter applications or laser ablation), or a birefringent polarizer element which produces a position offset but only an insignificant angle offset (4 f set-up, for example in the case of the use of Bessel-like beam profiles during glass separation or glass cutting).

In a further embodiment, the processing optical unit has at least one birefringent polarizer element, in particular a birefringent lens element, for producing a longitudinal offset between two partial beams having different polarization states, which are preferably focused into adjacent partial regions of the continuous interaction region. As has been described further above, a longitudinal offset between differently polarized partial beams can be produced by means of a birefringent lens element.

As has been described further above, the birefringent lens element can form the focusing optical unit, in principle, i.e. the processing optical unit does not have a further focusing element in order to focus the partial beams in the focus zones or in the partial regions of the interaction region, which are preferably focused into adjacent partial regions of the continuous interaction region.

Since the size or the diameter of the partial regions or of the focus zones is predefined by the focal length of the birefringent lens element in this case and there are only a limited number of birefringent materials available for producing the lens element, the longitudinal offset between the partial regions or the focus zones is predefined in this case.

It has therefore proved to be advantageous if the focusing optical unit has a non-birefringent focusing element, in particular a further lens element composed of a non-birefringent material, or consists of a focusing lens composed of a non-birefringent material. In combination with the birefringent lens element, in this case a desired effective focal length of the focusing optical unit can be defined and a desired longitudinal offset of the partial beams can be predefined or set.

Embodiments of the present invention also relates to a laser processing apparatus, comprising: a processing optical unit as described further above and also a laser source, in particular an ultrashort pulse laser source, for generating a laser beam, in particular a laser beam having a Gaussian beam profile. The laser source is preferably configured for generating a single-mode laser beam having a Gaussian beam profile, but this is not required.

The processing optical unit can be accommodated in a laser processing head or in a housing of a laser processing head, for example, which is movable relative to the workpiece. Alternatively or additionally, the laser processing apparatus can comprise a scanner device in order to align the partial beams with the workpiece or with different positions on the workpiece. Besides the optical units described further above, the processing optical unit can also have further optical units. The laser processing apparatus can also have a movement device, e.g. a linear drive, for moving, in particular for displacing, the workpiece along a feed direction.

In the following description of the drawings, identical reference signs are used for identical or functionally identical components.

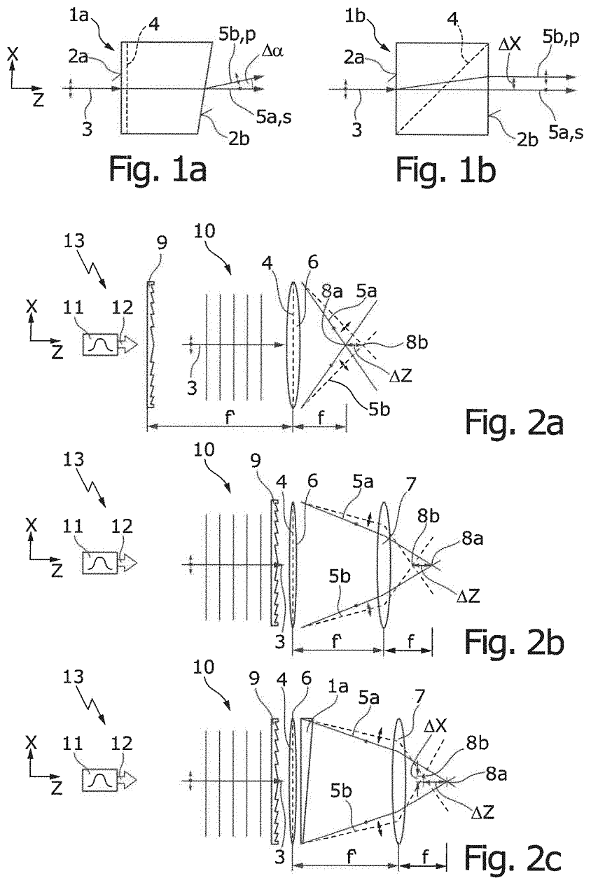

FIGS. 1a,b each show schematically a birefringent polarizer element 1a, 1b in the form of a birefringent crystal. Various birefringent materials can be used as crystal material for the polarizer element 1a, 1b, e.g. alpha-BBO (alpha-barium borate), YVO4 (yttrium vanadate), crystalline quartz, etc. The birefringent polarizer element 1a from FIG. 1a is configured in wedge-shaped fashion, i.e. a planar beam entrance surface 2a for the entrance of an input laser beam 3 and a planar beam exit surface 2b of the polarizer element 1a are oriented at a (wedge) angle with respect to one another. The or an optical axis 4 of the crystal material is oriented parallel to the beam entrance surface 2a.

The unpolarized or circularly polarized input laser beam 3 entering the birefringent polarizer element 1a perpendicularly to the beam entrance surface 2a is split into two partial beams 5a, 5b, which are perpendicular to one another (s- and p-polarized, respectively), i.e. which have one of two different polarization states, at the beam exit surface 2b, which is inclined at an angle with respect to the beam entrance surface 2a. In FIG. 1a, as generally customary, the s-polarized partial beam 5a is identified by a dot, while the second, p-polarized partial beam 5b is identified by a double-headed arrow. The first, p-polarized partial beam 5a is refracted to a lesser extent than the second, s-polarized partial beam 5a upon emergence from the birefringent polarizer element 1a, with the result that an angle offset Δα occurs between the first and second partial beams 5a, 5b. In this case, the first and second partial beams 5a, 5b emerge from the birefringent polarizer element 1a at the same location at the beam exit surface 2b, that is to say that the angle offset Δα, but no position offset, is produced between the two partial beams 5a, 5b.

In the case of the polarizer element 1b shown in FIG. 1b, the beam entrance surface 2a and the beam exit surface 2b are aligned parallel to one another and the optical axis 4 of the crystal material is oriented at an angle of 45° with respect to the beam entrance surface 2a. In this case, the input beam 3 impinging perpendicularly to the beam entrance surface 2a is split into a first partial beam 5a in the form of an ordinary ray and a second partial beam 5b in the form of an extraordinary ray at the beam entrance surface 2a. The two partial beams 5a, 5b emerge parallel, i.e. without an angle offset, but with a position offset Δx at the beam exit surface 2b.

The two birefringent polarizer elements 1a, 1b illustrated in FIGS. 1a and 1n FIG. 1b thus differ fundamentally in that the polarizer element 1a shown in FIG. 1a produces an angle offset Δα (without a position offset) and the polarizer element 1b shown in FIG. 1b produces a position offset Δx (without an angle offset). It goes without saying that for example the wedge-shaped polarizer element 1a illustrated in FIG. 1a can also be configured to produce both a position offset Δx and an angle offset Δα, as is the case in conventional prism polarizers, which generally comprise two birefringent optical elements.

FIGS. 2a-c each show a polarizer element in the form of a birefringent, focusing lens element 6, onto which a collimated input laser beam 3 is radiated. The input laser beam 3 is split into two partial beams 5a, 5b, which are perpendicular to one another (s- and p-polarized, respectively), at the birefringent lens element 6. In the example shown in FIG. 2a, the first, s-polarized partial beam 5a is refracted to a greater extent than the second, p-polarized partial beam 5b upon emergence from the birefringent lens element 6, with the result that a longitudinal (position) offset Δz is produced between a focus zone 8a of the first partial beam 5a and a focus zone 8b of the second partial beam 5a, 5b. The two focus zones 8a, 8b are illustrated in a punctiform fashion in FIGS. 2a-c in order to simplify the illustration, but overlap in a longitudinal direction (Z-direction). The birefringent lens element 6 is formed from a birefringent crystal, like the polarizer elements 1a, 1b.

In FIG. 2b, the birefringent focusing lens element 6 splits the input laser beam 3 between two partial beams 5a, 5b as in FIG. 2a. The first partial beam 5a, which is refracted to a greater extent at the birefringent lens element 6, is refracted to a lesser extent than the second partial beam 5b at a further, non-birefringent lens element 7, as a result of which a longitudinal offset Δz is likewise produced between the two focus zones 8a, 8b. In the case of the example illustrated in FIG. 2b, however, the focus zone 8a of the first partial beam 5a is further away from the birefringent lens element 4 in a longitudinal direction Z than the focus zone 8b of the second partial beam 5b.

In the case of the example shown in FIG. 2c, the wedge-shaped birefringent polarizer element 1a from FIG. 1a is arranged directly downstream of the birefringent lens element 6 in the beam path of the input laser beam 3. The wedge-shaped polarizer element 1a produces an additional lateral offset Δx of the focus zones 8a, 8b of the two partial beams 5a, 5b.

The lens elements 6, 7 shown in FIGS. 2a-c and also the wedge-shaped polarizer element 1a are part of a processing optical unit 10, which also comprises a diffractive beam splitter optical unit 9. The processing optical unit 10 is part of a laser processing apparatus 13, which additionally comprises a laser source 11 in the form of an ultrashort pulse laser source. The laser source 11 generates a laser beam 12, which has a Gaussian beam profile in the example shown and which enters the processing optical unit 10. At the diffractive beam splitter optical unit 9, the laser beam 12 is split into a plurality of beams of rays, which are aligned parallel to one another, for example, and which form a respective input laser beam 3 for the birefringent lens element 7. In order to simplify the illustration, only a single input laser beam 3 is shown in FIGS. 2a-c, said input laser beam being split between two partial beams 5a, 5b.

In the case of the example shown in FIG. 2a, the diffractive beam splitter optical unit 9 is arranged upstream of the birefringent lens element 6 at the distance of the entrance-side focal length f′. In this case, the birefringent lens element 6 forms the focusing optical unit of the processing optical unit 10 and focuses the partial beams 5a, 5b approximately at the distance of its exit-side focal length f. In the case of the examples shown in FIGS. 2b,c, by contrast, the focusing is substantially effected by the further, non-birefringent lens element 7. The birefringent lens element 6—just like the wedge-shaped polarizer element 1a shown in FIG. 2c—is arranged upstream of the further lens element 7 approximately at the distance of the entrance-side focal length f, said further lens element having a significantly higher refractive power than the birefringent lens element 6 and therefore also being referred to hereinafter as focusing lens or as focusing optical unit. The order of the arrangement of the birefringent lens element 6, the wedge-shaped polarizer element 1a and the diffractive beam splitter element 9 in the beam path is arbitrary, in principle, but in the case of the example shown in FIG. 2c they should typically be arranged approximately at the distance of the entrance-side focal length f′ from the focusing lens 7.

With the aid of the processing optical unit 10 shown in FIGS. 2a-c or the laser processing apparatus 13, the two partial beams 5a, 5b can be focused into two adjacent focus zones 8a, 8b, which at least partly overlap. A plurality of input laser beams 3 can be generated by means of the beam splitter optical unit 9, and are split into a plurality of pairs of partial beams 5a, 5b at the polarizer element(s) 1a, 6 and are focused into corresponding pairs of focus zones 8a, 8b. In this way, a continuous interaction region for the processing of a workpiece can be formed from the partly overlapping focus zones 8a, 8b, as is described in greater detail further below.

Owing to the possibility of producing both a lateral offset Δx and a longitudinal offset Δz of the focus zones 8a, 8b, a continuous interaction region describing an approximately arbitrary three-dimensional curve in space or in the X-Z-plane can be formed. In particular, the continuous interaction region can have a plurality of focus zones 8a, 8b or partial regions offset with respect to one another in a longitudinal direction Δz, as is described in greater detail further below.

In the examples below, the laser processing of a workpiece is effected by the movement of a continuous interaction region along a processing path, i.e. by the cumulation of mutually adjoining continuous interaction regions that form ablation and/or modification regions. In order to simplify the illustration, it is assumed in the examples below that a rectilinear feed of the workpiece is effected for the movement of the continuous interaction region. It goes without saying that in general any other feed geometries/courses of the processing path are possible. In particular, it is possible here to move not just the workpiece but also the processing optical unit or a laser processing head in which the processing optical unit is arranged.

With regard to modification regions/ablation regions succeeding one another in the feed direction, the geometry of the incident laser radiation, for example an angle range of the beam cross-section of the laser radiation, can be chosen such that when modification regions/ablation regions are lined up in the feed direction, a previously introduced modification and/or a previously processed ablation region have/has only an insignificant influence on the formation of the subsequent modifications/ablation regions.

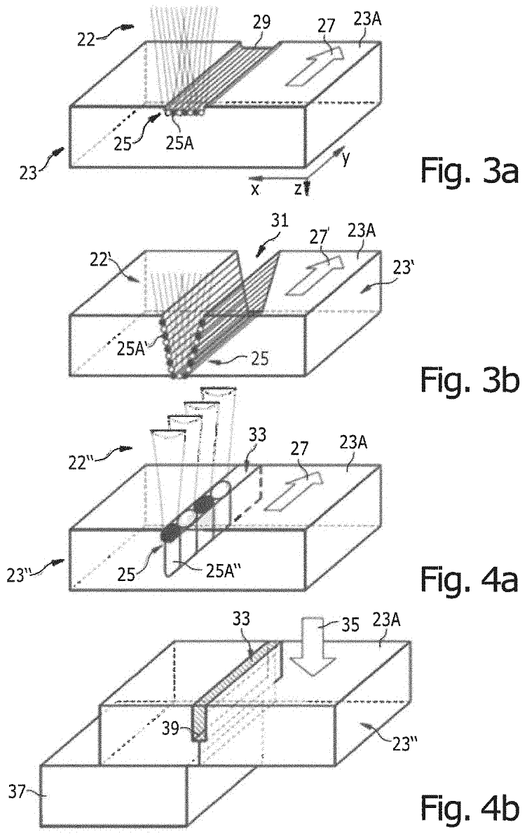

FIG. 3a shows a laser processing in the form of a laser ablation process in which, at a top side 23A of a plate-shaped workpiece 23, an ablation of workpiece material is performed by a plurality of partial beams 22 being focused onto the top side 23A of the plate-shaped workpiece 23, a linear continuous interaction region 25 being formed. In the interaction region 25, the partial regions 25A (focus zones) onto which the partial beams 22 are focused are lined up next to one another with alternating, different polarization states (e.g. s and respectively p) in the X-direction of an XYZ-coordinate system, adjacent partial regions 25A partly overlapping. The alternating polarization states (e.g. s and respectively p) are indicated by light and dark regions within the interaction region 25 and avoid interference of adjacent partial beams 22.

In FIG. 3a there is no offset of the partial regions 25A in the Z-direction, corresponding to the direction of propagation of the laser radiation (longitudinal direction), i.e. the partial regions 25A lie in a (focal) plane oriented perpendicularly to the longitudinal direction Z. An arrow 27 illustrated in FIG. 3a clarifies a relative movement of the interaction region 25 transversely with respect to the lining up direction (X-direction) in the form of a displacement of the workpiece 23 in the Y-direction. In the case of a linear feed, the laser processing gives rise to an ablated strip 29 having the width of the continuous interaction region 25 and a depth corresponding to the ablation power of the partial beams 22 in the partial regions 25A (i.e. in the focus zones).

FIG. 3b likewise shows a laser processing in the form of a laser ablation process in which material is ablated from the top side 23A of a plate-shaped workpiece 23′. As in FIG. 3a, in FIG. 3b as well a plurality of partial beams 22′ are focused onto the plate-shaped workpiece 23 for this purpose, a continuous interaction region 25 being formed. In contrast to FIG. 3a, the partial regions 25A′ are offset not only in a lateral direction (X-direction) but also additionally in a longitudinal direction (Z-direction) and are arranged in a V-shaped fashion by way of example in FIG. 3b. The relative movement of the workpiece 23′ in the Y-direction, i.e. transversely with respect to a plane (the X-Z-plane in FIG. 3b) spanned by the V-shaped profile of the interaction region 25, results in an ablated incision 31 having the V-shape of the continuous interaction region 25. In the case of the example shown in FIG. 3b, too, the alternating polarization states—once again indicated by light and dark regions—of directly adjacent partial beams 22′ bring about a homogeneous ablation that is not influenced by the interference of adjacent partial beams 22′. In order to produce the ablated incision 31 illustrated in FIG. 3b, the workpiece 23′ can be displaced in the Y-direction in a plurality of successive ablation steps, wherein between successive ablation steps the interaction region 25 having the V-shaped profile is displaced in the Z-direction, i.e. is sunk down further on the workpiece 23′. Alternatively or additionally, the geometry of the V-shaped interaction region 25 can be altered during the ablating laser processing; by way of example, it is possible to gradually enlarge the extension of the V-shaped interaction region 25 in the longitudinal direction Z, i.e. the V-shaped interaction region 25 becomes increasingly more pointed during successive ablation steps. The material of the workpiece 23, 23′ processed in an ablating manner in FIGS. 3a,b can be for example a metallic material, a glass material, etc.

FIG. 4a shows a laser processing for producing a structural modification of material of a plate-shaped workpiece 23″, said structural modification extending from the top side 23A of the workpiece 23″ along the direction of propagation (Z-direction) of the incident laser radiation or of the partial beams 22″ into the (transparent) workpiece 23″. For this purpose, a continuous interaction region 25 is formed by a lining up of partly overlapping elongate partial regions 25A″ (focus zones) of a plurality of partial beams 22″, said partial regions running next to one another (in the Y-direction in FIG. 4a). As in FIG. 3a there is no offset of the partial regions 25A″ in the Z-direction. Alternating polarization states (s and respectively p) are again indicated by light and dark regions. By way of example, FIG. 4a shows four elongate partial regions 25A″ caused by a suitable phase imposing on the partial beams 22″, thus resulting in the formation of e.g. elongated focus zones or partial regions 25A″ of Bessel beams or inverted Bessel beams. The elongated partial regions 25A″ can be produced by means of a beam-shaping optical unit of the processing optical unit 10, which can have e.g. an axicon or a diffractive optical element. For details of such a beam-shaping optical unit, reference should be made to DE 10 2019 205 394.7 cited further above. In order to produce the structural modification in the volume of the workpiece 23″ as well, the latter is formed from a material transparent to the laser beam 12 or to the wavelength of the laser beam 12, from glass in the example shown.

During a relative movement along the lining up direction, i.e. in the Y-direction, this gives rise to a material modification of a narrow strip 33 having the width of a single partial region 25A″. The depth of the strip 33 in the Z-direction is governed by the length of the elongated focus zones or partial regions 25A″. As is illustrated in FIG. 4a by dotted semicircles indicating the beam cross-section of the partial beams 22 used for processing, the partial beams 22 are preferably restricted to the leading angle portion or angle range, such that no disturbance of the laser beam and thus of the interaction as a result of modifications already produced occurs during the feed. In the example shown, the structural modification of the material of the workpiece 23″ leads to the formation of microcracks that weaken the glass material within the modified strip 33.

FIG. 4b shows how the workpiece 23″ is partly deposited or placed on a support 37 and a force (arrow 35) is exerted on the non-deposited side of the workpiece 23″. Below the modified strip 33, which represents a modification contour, a crack 39 forms through the entire thickness of the workpiece 23″, thus resulting in a separation of the workpiece 23″ into two segments.

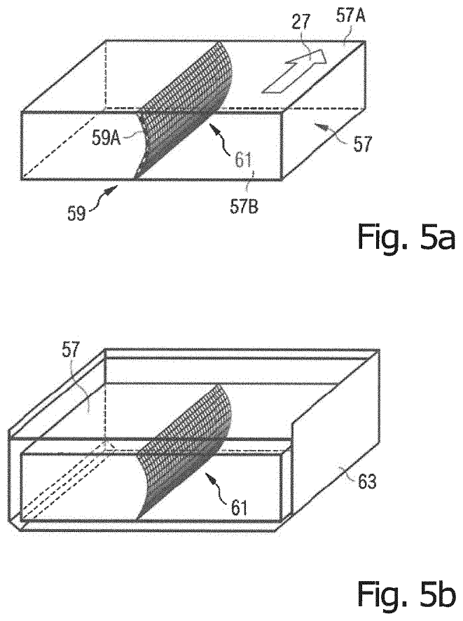

FIG. 5a shows a bent or curved lining up—deviating from a linear shape—of partial regions 59A of a continuous interaction region 59 in a (transparent) material of a plate-shaped workpiece 57. As in FIGS. 4a,b, a material modification is produced by means of the continuous interaction region 59, which extends in a curved fashion through the workpiece 57 from the top side 57A thereof to the underside 57B thereof. Adjacent partial regions or focus zones 59A of the interaction region 59 partly overlap, such that as a result of a relative movement of workpiece 57 and interaction region 59 (arrow 27) a continuous/uninterrupted bent modification contour in the form of a modification plane 61 is formed in the material.

FIG. 5b shows the modified workpiece 57 in an etching basin 63 (etching bath), in which the material of the workpiece 57 is removed in etching fashion in the region of the modification plane 61 in the example shown. This brings about as a result a separation of the workpiece 57 into two segments, as in FIGS. 4a,b.

In the case of the modification-based separation methods described further above, the separation of segments can automatically take place directly or after the laser processing or it can be induced by a further process, e.g. by the mechanical separating process described in association with FIGS. 4a,b, by the etching process described in association with FIGS. 5a,b, or by a thermal separating process, not illustrated in a figure.

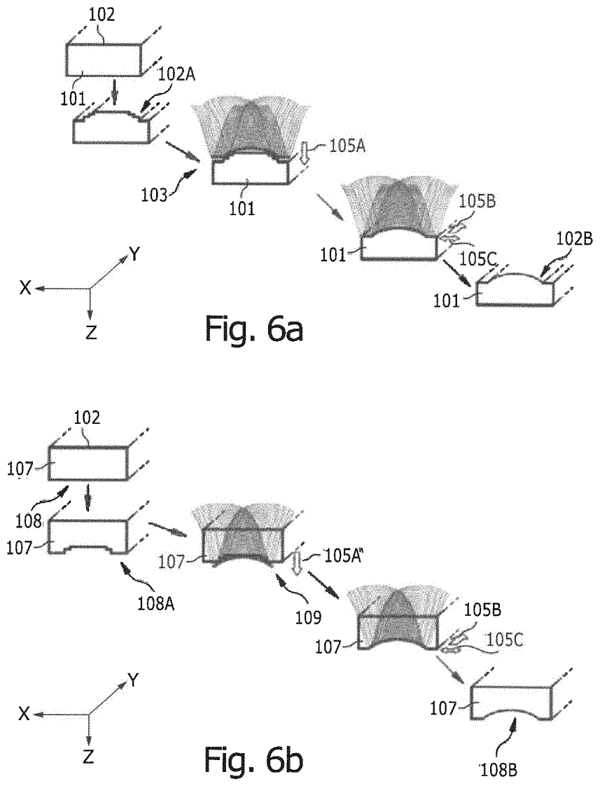

Besides the ablating or separating laser processing described further above, it is also possible to perform a surface processing with the aid of the multispot arrangement described further above or with the aid of a (at least one) continuous interaction region, i.e. the laser radiation or the laser processing apparatus 13 serves as a shaping tool. FIG. 6a shows by way of example a laser beam entrance-side processing of a workpiece 101, and FIG. 6b a laser beam exit-side processing of a workpiece 107.

In the case of the beam entrance-side processing by means of a continuous interaction region (multispot arrangement) as a shaping tool, consideration is given primarily to ablating or locally modifying methods. The modifying methods include, for example, polishing by way of local melting and use of a surface tension present.

FIG. 6a shows the use of a multispot laser shaping cutting edge for laser entrance-side ablation on a workpiece 101. A top side 102 of the workpiece 101 is optionally coarsely prestructured in a first processing step. This can be done for example with a throughput-optimized laser processing process of reduced precision and results in a coarsely structured surface 102A, which is intended to be converted into a sought freeform surface 102B with the aid of the laser shaping tool or by means of laser processing. A multispot focus curve or focus line in the form of a continuous interaction region 103 adapted to the sought freeform surface 102B is introduced at the correct position above the coarsely structured top side 102A and lowered onto the latter (arrow 105A) in order to ablate the material of the workpiece 101 in the region of the (curved) focus line 103. Just like further above, points or circles of the focus line 103 clarify partial regions lying next to one another and having different polarization components, with the result that interference between adjacent partial regions is avoided.

The lowering is followed by a relative movement (arrow 105B) between the multispot focus curve or the interaction region 103 and the workpiece 101, with the result that the surface 102A of the top side 102 acquires the desired shape. Furthermore, a reduction in the roughness of the surface 102B can optionally be effected by means of an offset of the spots of the multispot focus curve 103 in the direction of the focus line (arrow 105C) (e.g. SLM (“spatial light modulator”)-controlled). Alternatively or additionally, the multispot focus curve or the interaction region 103 as a whole can be rotated around the workpiece 101 in order to reduce roughness in a small angle range. In addition, the process parameters can be adapted in the course of the processing process in order after a laser milling or ablation step, for example, to attain a surface quality comparable to grinding (finer focus line) and then polishing (local melting).

FIG. 6b shows the use of a multispot laser shaping cutting edge for laser exit-side processing of a workpiece 107, i.e. at the underside 108 thereof. The processing steps are substantially analogous to the processing process illustrated in FIG. 6a (coarse structuring of the laser exit-side surface 108A, forming a multispot focus line or multispot focus curve 109 corresponding to a sought freeform surface 108B, raising the multispot focus curve 109 or optionally lowering the workpiece 107 (arrow 105A′), carrying out a relative movement (arrow 1053) between multispot focus curve 109 and workpiece 107, optionally reducing roughness (arrow 105C)). A processing of the laser exit side (underside 108) of the workpiece 107 presupposes a transparency of the workpiece 107 with corresponding optical quality of the entrance side (top side 102) and of the volume of the workpiece 107 in order that the energy of the laser radiation can be passed through the entrance surface and the volume as far as the laser exit side 108A of the workpiece 107.

In general, under these conditions, on the exit side it is possible to realize processing processes similar to those on the entrance side using a laser shaping tool, wherein remaining propagation-influencing properties of the volume and of the entrance surface of the workpiece 107 can be taken into account during the beam shaping. In the case of rear-side ablating processing methods using a laser shaping tool that are designed for a high ablation rate, it is advantageous that, in contrast to entrance-side processing, the ablation products do not influence the beam propagation as far as the processing zone.

It should be mentioned supplementarily that a plurality of continuous interaction regions can also be produced simultaneously during the laser processing, said interaction regions being spaced apart from one another in each case. In this regard, for example, a plurality of ablation regions or modifications of the material (e.g. within the workpiece for the purpose of marking the workpiece) that extend parallel on account of the same relative movement can be formed simultaneously.

The ablation or modification geometry is determined by the beam shaping of the laser beam or of the partial beams 22, 22′, 22″. Spatial gradients in adjacent focus zones or effective regions 25A, 25A′, 25A″ can be produced by means of suitable optical systems or processing optical units. The production of temporal gradients can be performed by means of the formation of pulse groups or a pulse shaping of the ultrashort pulse laser beam 12. For fast processing, it is possible to produce a single ablation or modification geometry with just a single laser pulse/single laser pulse group at the same time, such that a position on the workpiece is moved to only once in this case.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser processing of a workpiece, the method comprising:
splitting a pulsed laser beam among a plurality of partial beams, each partial beam having one of two different polarization states,
processing the workpiece by focusing the plurality of partial beams into a plurality of at least partially overlapping partial regions of a continuous interaction region, wherein partial beams having different polarization states are focused into adjacent partial regions of the continuous interaction region.

2. The method as claimed in claim 1, wherein the laser beam passes through a diffractive beam splitter and at least one birefringent polarizer during the splitting among the plurality of partial beams.

3. The method as claimed in claim 1, wherein during the splitting of the laser beam, at one or more birefringent polarizer elements, at least one of: a lateral offset or an angle offset is generated between two partial beams having different polarization states, the two partial beams are focused into adjacent partial regions of the continuous interaction region.

4. The method as claimed in claim 1, wherein during the splitting of the laser beam, at one or more birefringent polarizer elements, a longitudinal offset is generated between two partial beams having different polarization states, the two partial beams are focused into adjacent partial regions of the continuous interaction region.

5. The method as claimed in claim 4, wherein the one or more birefringent polarizer elements comprises a birefringent lens element.

6. The method as claimed in claim 1, wherein at least two partial regions of the continuous interaction region are offset with respect to one another in a longitudinal direction.

7. The method as claimed in claim 1, wherein, during the laser processing, the continuous interaction region and the workpiece are moved relative to one another along a feed direction.

8. The method as claimed in claim 1, wherein the interaction region forms an ablation region for ablating a material of the workpiece.

9. The method as claimed in claim 8, wherein the ablation region is formed at an entrance-side surface of the workpiece or at an exit-side surface of the workpiece, wherein during the laser processing, a predefined surface shape is generated at the entrance-side or at the exit-side surface.

10. The method as claimed in claim 1, wherein the interaction region forms a modification region for structural modification of a material of the workpiece, wherein the material of the workpiece is transparent to the laser beam.

11. The method as claimed in claim 10, wherein the material of the workpiece comprises glass.

12. The method as claimed in claim 10, wherein the workpiece is separated after the structural modification along a modification contour formed during the laser processing in a volume of the workpiece.

13. The method as claimed in claim 12, wherein the workpiece is separated by a mechanical process, a thermal process, or an etching process.

14. A processing optical unit for laser processing of a workpiece, the processing optical unit comprising:
a diffractive beam splitter and one or more birefringent polarizer elements for splitting a pulsed laser beam among a plurality of partial beams, each partial beam having one of two different polarization states, and
a focusing optical element for focusing the plurality of partial beams in a plurality of at least partly overlapping partial regions of a continuous interaction region, wherein the processing optical unit is configured to focus partial beams having different polarization states into adjacent partial regions of the continuous interaction region.

15. The processing optical unit as claimed in claim 14, wherein the one or more birefringent polarizer elements produce a lateral offset and/or an angle offset between two partial beams having different polarization states.

16. The processing optical unit as claimed in claim 14, wherein the one or more birefringent polarizer elements produce a longitudinal offset between two partial beams having different polarization states.

17. The processing optical unit as claimed in claim 16, wherein the one or more birefringent polarizer elements comprise a birefringent lens element.

18. A laser processing apparatus comprising:
a processing optical unit as claimed in claim 14, and
a laser source for generating the pulsed laser beam.

19. The laser processing apparatus as claimed in claim 18, wherein the pulsed laser beam has a Gaussian beam profile.
